(19) United States
(12) Patent Application Publication
(10) Pub. No.: US 2018/0208769 A1
(43) Pub. Date: Jul. 26, 2018

(54) EPOXY FUNCTIONALIZED ETHYLENE COPOLYMER ASPHALT REACTION PRODUCTS

(71) Applicant: E I DU PONT DE NEMOURS AND COMPANY, Wilmington, DE (US)

(72) Inventor: George Wyatt Prejean, Orange, TX (US)

(21) Appl. No.: 15/746,169

(22) PCT Filed: Jul. 15, 2016
(86) PCT No.: PCT/US16/42478

§ 371 Date: Jan. 19, 2018

Related U.S. Application Data
(60) Provisional application No. 62/195,947, filed on Jul. 23, 2015.

(51) Int. Cl. C08L 95/00

(52) U.S. Cl. CPC C08L 95/00; C08L 2555/84; C08L 2555/22

(57) ABSTRACT

This invention relates to polyepoxy-polymer-linked-asphalt having enhanced properties made by reacting a glycidyl-functionalized ethylene copolymer with reactive asphalt, wherein the glycidyl-functionalized ethylene copolymer has a glycidyl-containing comonomer content of 15.1 weight percent or greater.

### CROSS-REFERENCE TO RELATED APPLICATION

This application claims priority under 35 U.S.C. § 119 to U.S. Provisional Application No. 62/195,947, filed on Jul. 23, 2015, which is incorporated herein by reference in its entirety.

### FIELD OF THE INVENTION

This invention relates to a thermoplastic polymer alloy with asphalt that is useful in the road paving and roofing industries. More particularly, this invention relates to the reaction and resultant linking of epoxide-containing polymers to asphalt forming a polyepoxy-polymer-linked-asphalt composition having improved high temperature resistance, improved high elasticity at ambient and low temperatures as well as good toughness and tenacity values.

### BACKGROUND OF THE INVENTION

The use of bitumen in the manufacture of materials for highway and industrial applications has been known for a long time. Bitumen is the main hydrocarbon binder used in the field of road construction or civil engineering. To be able to be used as a binder in these different applications, the bitumen must have certain mechanical properties, and in particular elastic or cohesive properties. The mechanical properties of the bituminous compositions are determined by standardized tests of the different mechanical characteristics such as the softening point, the penetrability and the rheological characteristics in defined traction. Asphalts are performance graded (PG) by a set of specifications developed by the US federal government (Strategic Highway Research Program or SHRP). For example PG58-34 asphalt provides good rut resistance at 58° C. and good cold cracking resistance at −34° C., as determined by AASHTO (American Association of State Highway Transportation Officials) standards.

In general, the conventional bitumens do not simultaneously have all of the required qualities and it has been known for a long time that the addition of various polymers to these conventional bitumens makes it possible to modify the mechanical properties of the latter and to form bitumen-polymer compositions having improved mechanical qualities compared with those of the bitumens alone.

Asphalt sold for paving may be modified with polymers to improve rut resistance, fatigue resistance, cracking resistance, and can improve stripping resistance (from aggregate) resulting from increases in asphalt elasticity and stiffness. Addition of polymer to asphalt provides higher temperature rut resistance and improves fatigue resistance (increases the higher number of the PG rating). Good low temperature properties are to a large extent dependent on the specific asphalt composition (e.g., flux oil content, penetration index), but the polymer type does influence low temperature performance.

The asphalt industry considers polymers for asphalt modification to be either elastomers or plastomers. Generally elastomeric polymers improve low temperature performance and plastomeric polymers decrease it. The word plastomer indicates a lack of elastomeric properties. Plastomers are sometimes used to modify asphalt because they can increase stiffness and viscosity, which improves rut resistance, but they are generally considered inferior to elastomers due to lack of significant improvements in fatigue resistance, creep resistance, cold crack resistance, etc. Styrene/butadiene/styrene block copolymers (SBS), and ethylene/vinyl ester/glycidyl methacrylate terpolymer (EVAGMA) and ethylene/butyl acrylate/glycidyl methacrylate terpolymer (EnBAGMA), available from E. I. du Pont de Nemours and Company, Wilmington, Del., USA (DuPont) under the tradename Elvaloy® RET are considered elastomers. Polyethylene (PE) and ethylene vinyl acetate (EVA) resins are considered plastomers. PE is not miscible with asphalt, so asphalt modified with it must be continuously stirred to prevent separation. Asphalt modified with PE must be prepared at the mix plant and cannot be shipped due to separation. PE therefore acts as filler and does not meaningfully increase the softening point of asphalt.

Among the polymers added to bitumens, random or block copolymers of an aromatic monovinyl hydrocarbon and a conjugated diene and in particular of styrene and butadiene or of styrene and isoprene are known. U.S. Pat. Nos. 3,440,195, 4,145,322, 4,172,061, 4,217,259, 4,585,816 and 6,087,420 disclose asphalts modified with styrene/conjugated-diene block copolymers.

Also, bitumen-polymer compositions for which a random or block copolymer of styrene and a conjugated diene such as butadiene or isoprene is coupled with the bitumen can be prepared using the processes described in the citations FR-A-2376188, FR-A-2429241, FR-A-2528439 and EP-A-0360656. In these processes, the source of sulfur consists of chemically non-bound sulfur (FR-A-2376188 and FR-A-2429241), in a polysulfide (FR-A-2528439) or in a sulfur-donor vulcanization accelerator used alone or in combination with chemically non-bound sulfur and/or a polysulfide or a non-sulfur-donor vulcanization accelerator (EP-A-0360656).

The use of other polymers as additives to asphalt (bitumen) is also known in the art. See for example U.S. Pat. Nos. 4,650,820 and 4,451,598, wherein terpolymers derived from ethylene, an alkyl acrylate and maleic anhydride are mixed with bitumen.

Also see for example U.S. Pat. Nos. 5,306,750, 6,117,926 and 6,743,838 and U.S. Patent Application Publication 2007/0027261, wherein reactant epoxy-functionalized, particularly glycidyl-containing, ethylene terpolymers are mixed and reacted with bitumen and, as taught in U.S. Pat. No. 6,117,926, with a catalyst to accelerate the rate of reaction and lower cost of the modified system. DuPont Elvaloy® RET resins are excellent modifiers for asphalt and improve asphalt performance at low concentrations (1 to 2 weight %). The improvement in asphalt properties with addition of Elvaloy® RET at such low concentrations may be due to a chemical reaction between the Elvaloy® RET and the functionalized polar fraction of asphalt (asphaltenes).

Styrene/conjugated-diene block copolymers have also been used in combination with other types of polymers to prepare polymer-modified asphalt compositions (see for example, U.S. Pat. Nos. 3,978,014, 4,282,127 and 6,011,094). U.S. Pat. No. 5,331,028 discloses asphalts modified with a combination of a glycidyl-containing ethylene copolymer and a styrene/conjugated-diene block copolymer.

U.S. Pat. No. 9,028,602 discloses a bituminous composition comprising a bitumen in an amount ranging from 20 to 90 weight %, a carboxylic additive in an amount of from 0.25 to 5 weight %, and sulfur in an amount of 5 to 75 weight %, all percentages based on the weight of bitumen, carboxylic additive and sulfur, wherein the carboxylic additive is selected from carboxylic acids, carboxylic esters and carboxylic anhydrides.

Mixing asphalt with elastomers such as ENBAGMA and EVAGMA requires significant mixing at elevated temperatures to achieve the benefits of their addition. The polymers are presented in pellet form and are added to hot asphalt where the pellets soften and melt due to the heat and the stirring. Acids such as polyphosphoric acid (PPA) are sometimes added to reduce the reaction time with asphalt. Addition of acid can be a negative in some cases (e.g., customer perception that acid is bad or intolerance to amine antistrips). The reaction occurs with heat alone but may take longer (6 to 24 hours without acid compared to 1 to 6 hours with acid) and the resultant polymer modified asphalt (PMA) may not be as elastic (as evidenced by a higher phase angle and low elastic recovery). Some PMA producers prefer acid additives and some prefer heat alone. Heat reaction does eliminate the problem with amine antistrips. In some areas, use of acid to accelerate mixing of polymers with asphalt is being discouraged.

Use of acid may also promote emissions of H₂S from asphalt, which often contains sulfur or sulfur-containing compounds.

Accordingly, it is desirable to prepare polymer-modified asphalt compositions without using acid to accelerate the blending process.

### SUMMARY OF THE INVENTION

This invention provides a polyepoxy-polymer-linked-asphalt composition (particularly for use in paving applications) comprising

a. about 90 to about 99.5 weight percent (weight %), based on total of component a and component b, asphalt; and

b. about 0.5 to about 10 weight %, based on total of component a and component b, of an E/X/Y/Z epoxy-functionalized ethylene copolymer, wherein E is the copolymer unit (CH₂CH₂) derived from ethylene; X is the copolymer unit (CH₂CR¹R²), where R¹ is hydrogen, methyl, or ethyl, and R² is carboalkoxy, acyloxy, or alkoxy of 1 to 10 carbon atoms (X for example is derived from alkyl acrylates, alkyl methacrylates, vinyl esters, and alkyl vinyl ethers), present in from 0 to 40 weight % of the copolymer; Y is the copolymer unit (CH₂CR³R⁴), where R³ is hydrogen or methyl and R⁴ is carboglycidoxy or glycidoxy (Y for example is derived from glycidyl acrylate, glycidyl methacrylate, or glycidyl vinyl ether) present in from 15.1 to 25 weight % of the copolymer, and 0 to 10 weight % of copolymer units Z derived from comonomers including carbon monoxide, sulfur dioxide, acrylonitrile, or other monomers.

### DETAILED DESCRIPTION

All references disclosed herein are incorporated by reference.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the terms “a” and “an” include the concepts of “at least one” and “one or more than one”. The word(s) following the verb “is” can be a definition of the subject.

The transitional phrase “consisting of” excludes any element, step, or ingredient not specified in the claim, closing the claim to the inclusion of materials other than those recited except for impurities ordinarily associated therewith.

The transitional phrase “consisting essentially of” limits the scope of a claim to the specified materials or steps and those that do not materially affect the basic and novel characteristic(s) of the claimed invention. Optional additives as defined herein, at levels that are appropriate for such additives, and minor impurities are not excluded from a composition by the term “consisting essentially of”. Moreover, such additives may possibly be added via a masterbatch that may include other polymers as carriers, so that minor amounts (less than 5 or less than 1 weight %) of polymers other than those recited may be present. Therefore, the term “consisting essentially of” in relation to polymeric compositions is to indicate that substantially (greater than 95 weight % or greater than 99 weight %) the only polymer(s) present in a component is the polymer(s) recited.

When the term “about” is used in describing a value or an end-point of a range, the disclosure should be understood to include the specific value or end-point referred to.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present). When present an optional component may be at least 0.1 weight % of the composition or copolymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of acrylic acid”. A description of a copolymer with reference to its constituent comonomers or to the amounts of its constituent comonomers means that the copolymer contains copolymerized units (in the specified amounts when specified) of the specified comonomers. Polymers having more than two types of monomers, such as terpolymers, are also included within the term “copolymer” as used herein. A dipolymer consists essentially of two copolymerized comonomers and a terpolymer consists essentially of three copolymerized comonomers. The term “consisting essentially of” in reference to copolymerized comonomers allows for the presence of minor amounts (i.e. no more than 0.2 weight %) of non-recited copolymerized units, for example arising from impurities present in the commoner feedstock or from decomposition of comonomers during polymerization.

“(Meth)acrylic acid” includes methacrylic acid and/or acrylic acid and “(meth)acrylate” includes methacrylate and/or acrylate.

The terms “asphalt” and “bitumen” are used somewhat interchangeably in the industry and herein to refer to the viscous compositions used for paving and roofing applications. “Bitumen” typically refers to the primarily hydrocarbon base material that is mixed with other components. “Asphalt” may be also used to refer to the final composition, including additives and aggregates as described below. In the remainder of the description, for reasons of simplicity, the term “polymer-modified asphalt” and the acronym PMA will be used to refer to a polymer modified bitumen or asphalt composition or to a cross-linked bitumen (asphalt)/polymer composition.

As summarized above, this invention provides a polyepoxy-polymer-linked-asphalt composition comprising about 90 to about 99.5 weight percent (weight %) Reactant Asphalt, preferably as described below, reacted with about 0.5 to about 10 weight % Epoxy-Functionalized Ethylene Copolymer, preferably as described below (weight % based on total of Reactant Asphalt and Epoxy-Functionalized Ethylene Copolymer). The invention further relates to the above polyepoxy-polymer-linked-asphalt compositions modified by the addition of Non-Reactive Polymers, preferably as described below. Optionally, the invention relates to a polyepoxy-polymer-linked-asphalt composition comprising Reactant Asphalt, preferably as described below, reacted with about 0.5 to about 10 weight % of Epoxy-Functionalized Ethylene Copolymer, preferably as described below, and about 1 to about 18 weight % of nonreactive polymers as described below.

### Reactant Asphalt

The bitumen or asphalt base used in the invention comprises one or more bitumens of different origins. Representative sources for asphalts include native rock, lake asphalts, petroleum asphalts, airblown asphalts, cracked or residual asphalts. Bitumens may be of natural origin, such as those contained in deposits of natural bitumen, natural asphalt or bituminous sands.

Asphalt more commonly can be obtained as a residue in the distillation or refining of petroleum, such as from vacuum tower bottoms (VTB). All types of asphalts (bitumens) are useful in this invention whether they be natural or synthetic. These bitumens can be optionally blown, visbroken and/or deasphalted. The bitumens can be bitumens of hard or soft grade. The different bitumens obtained by the refining processes can be combined with each other in order to obtain the best technical compromise.

Chemically asphalt is a complex mixture of hydrocarbons, which can be separated into two major fractions, asphaltenes and maltenes. The asphaltenes are polycyclic aromatics and most contain polar functionality. Some or all of the following functionalities are present: carboxylic acids, amines, sulfides, sulfoxides, sulfones, sulfonic acids, porphyrin rings chelated with V, Ni and Fe. The maltene phase contains polar aromatics, aromatics, naphthene. It is generally believed that asphalt is a colloidal dispersion with the asphaltenes dispersed in the maltenes; the dispersing agent being the polar aromatics. The asphaltenes are relatively high in molecular weight (about 1500) as compared with the other components of asphalt. The asphaltenes are amphoteric (acid and base on same molecule) in nature and form aggregates through self-association that offer some viscoelastic behavior to asphalt. Asphaltenes vary in amount and functionality depending on the crude source from which the asphalt is derived. Examples of asphalts include Ajax, Marathon, Wyoming Sour, Mayan, Venezuelan, Canadian, Arabian, Trinidad Lake, Salamanca and combinations of two or more thereof.

All asphalts containing asphaltenes can be used. The asphalt can be of low or high asphaltene content. Under these circumstances, the asphaltene concentration in the composition can range from about 0.0001 to about 5 weight % such that the asphalt can react with the ethylene copolymers but may not react with either acids such as SPA catalyst or heat (see, e.g., U.S. Pat. No. 6,117,926). For example but not limitation, the asphaltene content can be from about 0.01 to about 30, about 0.1 to about 15, about 1 to about 10, or about 1 to about 5%, by weight. High asphaltene asphalts typically contain more than 7 weight % asphaltenes or more than 10 weight % asphaltenes. Generally, the asphalts useful in this invention will contain less than 5 weight % oxygen compounds and frequently less than 1 weight % oxygen compounds.

The bitumens are advantageously chosen from road-surface bitumens of classes 10/20 to 160/220 and special bitumens of all classes.

The preferred proportions of the bitumen base present in the PMA represent between 90% and 99.4% by mass, preferably between 94% and 99% by mass, based on the total mass of the polymer/bitumen mixture.

Preferred asphalts have a viscosity at 60° C. of 100 to 20,000 poise, preferably 200 to 10,000, more preferably 300 to 4000, and still more preferably 400 to 1500 poise.

A modified asphalt may also be used. For example, a sulfonated asphalt or salt thereof (e.g., sodium salt), an oxidized asphalt, or combinations thereof may be used in combination of the asphalt disclosed above.

### Epoxy-Functionalized Ethylene Copolymer

Reactant epoxide-containing polymers useful in the present invention contain epoxide moieties (oxiranes) that react with the asphalt. The epoxide moiety comprises a cyclic structure consisting of two saturated carbon atoms and an oxygen atom. Typically, the reactant epoxide-containing polymers useful in this invention will have a melt flow index as determined by ASTM D1238-65T, Condition E, in the range from of from 0.1 to 500, preferably 0.5 to 200 and more preferably 1 to 100. Reactant polymers may be copolymers derived from two or more monomers (such as tetrapolymers), preferably three monomers (terpolymers) or two monomers (dipolymers).

Preferred Epoxy-Functionalized Ethylene Copolymers useful in this invention are glycidyl-containing polymers. Glycidyl-containing ethylene copolymers and modified copolymers useful in this invention are well known in the polymer art and can readily be produced by the concurrent reaction of monomers in accordance with U.S. Pat. No. 4,070,532.

The glycidyl-containing, epoxy-functionalized ethylene copolymers will contain from a lower limit of 15.1 or 16 to an upper limit of 20 or 25 weight % of comonomer(s) containing glycidyl moieties based on the total weight of the epoxy-functionalized ethylene copolymer. The glycidyl moiety may be represented by the following formula:

Preferred epoxy-functionalized ethylene copolymers useful in this invention may be represented by the formula: E/X/Y/Z, where E is the copolymer unit —(CH₂CH₂)— derived from (“of”) copolymerized units of ethylene; X is the copolymer unit —(CH₂CR¹R²)—, where R¹ is hydrogen, methyl, or ethyl, and R² is carboalkoxy, acyloxy, or alkoxy of 1 to 10 carbon atoms (X for example is derived from copolymerized units of alkyl acrylates, alkyl methacrylates, vinyl esters, and alkyl vinyl ethers); and Y is the copolymer unit —(CH₂CR³R⁴)—, where R³ is hydrogen or methyl and R⁴ is carboglycidoxy or glycidoxy (Y for example is derived from copolymerized units of glycidyl acrylate or glycidyl methacrylate) and Z is the copolymer unit derived from copolymerized units of comonomers including carbon monoxide, sulfur dioxide, acrylonitrile, or other monomers. For purposes of this invention the epoxy-containing comonomer unit, Y, may also be derived from copolymerized units of vinyl ethers of 1 to 10 carbon atoms (e.g., glycidyl vinyl ether) or mono-epoxy substituted di-olefins of 4 to 12 carbon. The R⁴ in the above formula includes an internal glycidyl moiety associated with a cycloalkyl monoxide structure; e.g., Y derived from vinyl cyclohexane monoxide. Preferably, X is a C₁-C₁₀ alkyl (meth)acrylate, particularly iso-butyl acrylate, n-butyl acrylate, iso-octyl acrylate, or methyl acrylate. Preferably, Y is selected from glycidyl acrylate or glycidyl methacrylate.

For this preferred embodiment, useful weight %'s (based on total weight of E, X, Y and Z in the copolymer) of the E/X/Y/Z epoxy-functionalized ethylene copolymer units preferably are 0 to about 40 (or about 10 to about 25) weight % of X, 15.1 to 25 weight % of Y and 0 to 10 weight % of copolymer units Z derived from comonomers including carbon monoxide, sulfur dioxide, acrylonitrile, or other monomers, and the remainder E. It is also preferred that the epoxy containing monomers are incorporated into the epoxy-functionalized ethylene copolymer by the concurrent reaction of monomers (direct polymerization) and not by grafting onto the reactant polymer by graft polymerization.

A notable glycidyl-containing polymer is ethylene glycidyl methacrylate (EGMA), an E/X/Y/Z copolymer wherein X and Z are 0 weight %. Other notable copolymers include ethylene/n-butyl acrylate/glycidyl methacrylate (EnBAGMA) and ethylene/vinyl acetate/glycidyl methacrylate (EVAGMA) copolymers.

Preferrred copolymers include E/X/Y terpolymers comprising 10 to 25 weight % of alkyl (meth)acrylate or vinyl acetate and 15.1 to 25 weight % of glycidyl methacrylate, such as EnBAGMA copolymers comprising 20 to 25 weight % of n-butyl acrylate and 15.1 to 20 weight % of glycidyl methacrylate, or EVAGMA copolymers comprising 10 to 15 weight % of vinyl acetate and 15.1 to 20 weight % of glycidyl methacrylate. More preferred copolymers include terpolymers comprising 10 to 25 weight % of alkyl (meth)acrylate or vinyl acetate and 16 to 25 weight % of glycidyl methacrylate, including EVAGMA copolymers comprising 10 to 15 weight % of vinyl acetate and 16 to 20 weight % of glycidyl methacrylate.

### Non-Reactive Polymers

Further, non-reactive diluent polymers known in the art may be included in the polyepoxy-polymer-linked-asphalt composition. Non-reactive polymers are polymeric compositions known in the art for inclusion in polymer-modified asphalt that do not react with the asphalt. Preferably, these non-reactive polymers also do not react with the epoxy-functionalized ethylene copolymers. They are sometimes referred to as “diluent” polymers.

These non-reactive polymers may include ethylene acrylate or vinyl acetate copolymers, styrene/conjugated-diene block copolymer such as styrene butadiene, or isoprene, or ethylene butene block copolymers (e.g., SBS, SIS, SEBS block copolymers) or polyolefins produced by any process known in the art with any known transition metal catalysts.

### Styrene/Conjugated-Diene Block Copolymers

Preferred non-reactive polymers include styrene/conjugated-diene block copolymers. They are well known polymers derived from styrene and a conjugated-diene, such as butadiene, isoprene, 1,3-pentadiene and the like. For simplicity, the term “styrene-butadiene-styrene” block copolymer, or “SBS” copolymer, unless specified more narrowly, will be used herein to refer to any such polymers.

The styrene/conjugated-diene block copolymers employed herein may be di-, tri- or poly-block copolymers having a linear or radial (star or branched) structure, with or without a random junction. Suitable block copolymers include, for example, diblock A-B type copolymers; linear (triblock) A-B-A type copolymers; and radial (A-B)ₙ type copolymers; wherein A refers to a copolymer unit derived from styrene and B refers to a copolymer unit derived from a conjugated-diene. Preferred block copolymers have a linear (triblock) A-B-A type structure or a radial (A-B)ₙ type structure.

Generally, the styrene/conjugated-diene block copolymer will contain about 10 to about 50 weight percent of copolymer units derived from styrene and about 50 to about 90 weight percent of copolymer units derived from a conjugated diene, preferably butadiene or isoprene, more preferably butadiene. More preferably, 20 to 40 weight percent of the copolymer units will be derived from styrene, the remainder being derived from the conjugated-diene.

Preferably, the styrene/conjugated-diene block copolymers have a weight-average molecular weight of from a lower limit of about 10,000, 30,000, 100,000, 150,000 or 200,000 daltons to a higher limit of about 500,000, 600,000, 750,000 or 1,000,000 daltons. The weight-average molecular weight of the styrene/conjugated-diene block copolymer can be determined using conventional gel permeation chromatography.

The melt flow index of the styrene/conjugated-diene block copolymer will typically be in the range from about 0 to about 200, preferably 0 to 100, more preferably 0 to 10, as determined by ASTM Test Method D 1238, Condition G.

Notable SBS copolymers have an overall content of 50 to 95% by weight of butadiene and the content of units containing a 1,2 double bond resulting from butadiene of 12 to 50 weight % of the copolymer. The weight-average molecular mass of the copolymer of styrene and of butadiene can be between 10,000 and 600,000 daltons, preferably between 30,000 and 400,000 daltons.

The copolymers of styrene and conjugated-diene can be prepared by anionic polymerization of the monomers in the presence of initiators composed of organometallic compounds of alkali metals, in particular organolithium compounds, such as alkyllithium and very especially butyllithium, the preparation being carried out at temperatures of less than or equal to 0° C. and in solution in a solvent that is at least partly composed of a polar solvent, such as tetrahydrofuran or diethyl ether. Preparation procedures include those described in U.S. Pat. Nos. 3,281,383 and 3,639,521.

Suitable styrene/conjugated-diene block copolymers are commercially available, for example, under the tradenames KRATON®, EUROPRENE SOL® and SOLPRENE® from Shell Chemical Company, Enichem and Phillips Petroleum Company, respectively.

Specific SBS copolymers include a block copolymer with a weight-average molecular mass of 120,000 and containing, by weight, 25% of styrene and 75% of butadiene, including an amount of units containing a 1,2 double bond representing 9% of the copolymer;

a diblock copolymer of styrene and of butadiene with a random junction having a weight-average molecular mass of 280,000 and containing 15% of styrene, including 10% in the block form, and 85% of butadiene, including 8% in the form of units containing a 1,2 double bond;

a diblock copolymer of styrene and of butadiene having a weight-average molecular mass of 120,000 and containing 25% of styrene and 75% of butadiene, including an amount in the form of units containing a 1,2 double bond representing 30% of the copolymer; and

a diblock copolymer of styrene and of butadiene with a random junction having a weight-average molecular mass of 150,000 and containing 25% of styrene, including 17% in block form, and 75% of butadiene, including an amount in the form of units containing a 1,2 double bond representing 35% of the copolymer.

These non-reactive polymers can be combined into the reactive asphalt, epoxy-functionalized ethylene copolymers and optional functionalized polyolefins so they comprise 0 weight % to 18 weight % of the final polymer-linked-asphalt composition, preferably 0.1 to 15 weight %, more preferably 0.5 to 10 weight % or 0.1 to 5 weight %, such as 1 weight % to 5, 10, 15 or 18 weight %. Notable compositions comprise 0% of SBS, SIS, SEBS block copolymers. Other notable compositions comprise from a lower limit of 0.1, 0.5 or 1 weight % to an upper limit of 5, 10, 15 or 18 weight % of SBS, SIS, SEBS block copolymers.

Other non-polymeric additives may be present in the polymer modified asphalt. For example, the asphalt composition may also optionally comprise an acid or acid source, flux oil or liquid plasticizer, amine scavenger, or hydrogen sulfide scavenger or any combination thereof.

The asphalt composition optionally includes an acid or acid source to accelerate mixing. Inorganic acid or organic acid can be used such as mineral acids, phosphoric acids, sulfonic acids, carboxylic acids, or combinations of two or more thereof. Examples of frequently used acids include polyphosphoric acid, phosphoric acid anhydride and/or titanates. Previously, mixing asphalt with elastomers such as ENBAGMA and EEGMA required significant mixing at elevated temperatures to achieve the benefits of their addition. The polymers are presented in pellet form and are added to hot asphalt where the pellets soften and melt due to the heat and the stirring. Acids are sometimes added to reduce the reaction time with asphalt. The asphalt composition can comprise from a lower limit of about 0.001, about 0.005, about 0.01, about 0.05, or about 0.1 weight % to an upper limit of about 2, about 3, about 5 or about 10 weight % of the acid. The reaction occurs with heat alone but takes it longer (6 to 24 hours without acid compared to 1 to 6 hours with acid) and the resultant polymer modified asphalt (PMA) is not as elastic (as evidenced by a higher phase angle and low elastic recovery). Some PMA producers prefer acid additives and some prefer heat alone. Addition of acid can be a negative in some cases (e.g., customer perception that acid is bad or intolerance to amine antistrips). Heat reaction does eliminate the problem with amine antistrips. In some areas, use of acid to accelerate mixing of polymers with asphalt is being discouraged. Also, acid treatment can cause asphalts modified with ethylene copolymers comprising high GMA levels to gel, making them unsuitable.

Surprisingly, polymer-modified asphalt compositions comprising ethylene copolymers with high levels of GMA prepared without the use of an acid or acid source have properties such as DSR fail temperature, phase angle and elastic recovery comparable to or superior to PMA compositions with ethylene copolymers with GMA content less than 15 weight % with added acid. Especially noteworthy is the superior elastic recovery of PMA compositions comprising the high GMA described herein without the use of an acid or acid source compared to compositions with ethylene copolymers with lower GMA content prepared using acid. Accordingly compositions comprising no acid are preferred. Of note are compositions comprising the ethylene copolymers with GMA content of 15.1 weight % to 25 weight % that do not comprise an acid or an acid source.

Flux oils can encompass many types of oils used to modify asphalt and may be obtained from crude oil distillation. They are non-volatile oils that are blended with asphalt to soften it. They can be aromatic such as Paulsboro's ValAro, paraffinic such as HollyFrontier's Hydrolene®, mineral such as Sonnerborn's Hydrobryite®. Flux oils can also be any renewable-produced vegetable or bio-oil.

A liquid plasticizer is an additive that increases the plasticity or fluidity of a material. The major applications are for plastics, such as phthalate esters for improving the flexibility and durability of polymer compositions. Examples of liquid plasticizers are carboxylate esters including, but not limited to, any dicarboxylic or tricarboxylic ester-based plasticizers, such as bis(2-ethylhexyl) phthalate (DEHP), di-octyl phthalate (DOP), diisononyl phthalate (DINP), diisodecyl phthalate (DIDP). Liquid plasticizers also include acetic acid esters of monoglycerides made from castor oil; or other nonphthalate plasticizers for PVC including trimellitates such as tris(2-ethylhexyl) trimellitate, adipates such as bis(2-ethylhexyl) adipate, benzoates such as 1,5-pentanediol dibenzoate, adipic acid polyesters, polyetheresters, epoxy esters or maleates.

A hydrogen sulfide scavenger is an agent capable of neutralizing hydrogen sulfide or H₂S. It is a compound or a mixture of compounds which in the presence of H₂S combines with the latter so as to collect and/or scavenge it, thus reducing or eliminating the emission and/or the release of H₂S at PMA storage, transfer and transport temperatures. For the sake of simplicity, the word “scavenger” is used in the remainder of the description to refer to the agent capable of reducing H₂S emissions. The use of an H₂S scavenger makes it possible to significantly reduce, or advantageously to eliminate, the release of H₂S during the preparation, loading and/or unloading of a bitumen/polymer composition. Hydrogen sulfide scavengers include those described in PCT patent application publication WO2005065177, U.S. Patent Application Publication 2014/0357774 and co-pending U.S. Patent Application Ser. No. 62/166,733.

The asphalt composition may also include a sulfur source such as elemental sulfur, a sulfur donor, a sulfur byproduct, or combinations of two or more thereof, useful as crosslinking agents, as described in co-pending U.S. Patent Application Ser. No. 62/166,733.

### Process for Making a Polyepoxy-Polymer-Linked-Asphalt Composition

The process for making the polyepoxy-polymer-linked-asphalt compositions of this invention can be any process well known to those skilled in the art for reacting GMA copolymers with asphalt. The polyepoxy-polymer-linked-asphalt composition of this invention may be made in accord with the processes described in U.S. Pat. Nos. 5,306,750 and 6,117,926. Preferably, the polyepoxy-polymer-linked-asphalt composition is made by melt-mixing the asphalt, the epoxy-functionalized ethylene copolymer, and optional non-reactive polymers and continuing to mix them until the properties of the polymer modified asphalt reach their optima, optionally in the presence of accelerant materials such as polyphosphoric acid, phosphoric acid anhydride and/or titanates.

An example process for blending epoxy-containing polymers such as ENBAGMA with asphalt includes:

1) heating the base bitumen or asphalt to 165 to 195° C. either prior to or after addition to a reactor for modifying with the epoxy-containing polymer and the optional non-reactive polymer;

2) adding the epoxy-containing polymer to the heated asphalt in the reactor with stirring while maintaining the temperature at about 180 to about 195° C. for sufficient time to blend the polymer with the asphalt; and optionally

3) adding an acid and mixing for additional time to blend the optional acid with the asphalt.

Depending on the mixing procedure used, addition of the polymer to the asphalt may take from a few minutes to several hours, such as about three minutes or about 15 minutes, to about 1 to 4 hours. Mixing the acid with the asphalt may also take from a few minutes to several hours, such as about three minutes or about 15 minutes, to about 1 to 4 hours. When an acid is not used, the mixing of the asphalt and the polymer may require longer mixing times such as greater than five or six hours to provide complete reaction.

An example process for blending non-reactive elastomeric polymers such as styrene conjugated-diene copolymers and epoxy-containing ethylene copolymers such as ENBAGMA or EVAGMA as described herein with asphalt includes:

1) heating the base bitumen or asphalt to 165 to 195° C. either prior to or after addition to a reactor for modifying with the epoxy-containing polymer and the non-reactive polymer;

2) adding the non-reactive polymer to the heated asphalt in the reactor with stirring while maintaining the temperature at about 180 to about 195° C. for sufficient time to blend the non-reactive polymer with the asphalt; and

3) adding the epoxy-containing ethylene copolymer to the heated asphalt in the reactor with stirring while maintaining the temperature at about 180 to about 195° C. for sufficient time to blend the epoxy-containing polymer with the asphalt.

Notably, blending of the non-reactive polymer and the epoxy-containing ethylene copolymer can be carried out in the absence of added acid sources.

PMAs have been typically produced in a high sheer mill process, or a low sheer mixing process, as is well known to one skilled in the art. For example, the process is dependent on the equipment available, and on the polymers used. Polymers that can be used in low sheer mixing equipment can be used in high sheer equipment also. A molten mixture of asphalt and polymer modifiers can be heated at about 160 to about 250° C., or about 170 to 200° C. An acid catalyst may be added to facilitate reaction between the asphalt and the modifier. The molten mixture can be mixed by, for example, a mechanical agitator or any other mixing means.

A good example on how PMA can be produced commercially can be found in publications IS-200, from the Asphalt Institute, Lexington, Ky.

Use of flux oil or a liquid plasticizer as described herein may provide an improved process for mixing polymer modifiers with asphalt. The epoxy-containing polymer, the non-reactive polymer, or both can be dissolved in the flux oil or the liquid plasticizer and subsequently added to the heated asphalt, as described in co-pending U.S. Patent Application Ser. No. 62/121,078.

The invention can be used whenever an elastomeric modification of asphalt is desired. The modified asphalt can then be used in road pavement applications, or in roofing applications, or in any other application typically using an elastomeric modified asphalt. This modified asphalt composition can be mixed with aggregates at a ratio of about 1 to about 10 or about 5% asphalt, about 90 to about 99 or about 95% aggregates and used for paving. Polymer-modified asphalts can be used for paving of highways, city streets, parking lots, ports, airfields, sidewalks, and many more. Polymer-modified asphalts can also be used as a chip seal, emulsions, or other repair product for paved surfaces.

The asphalt composition disclosed here can also be used as a roofing or waterproofing product. Highly modified asphalt can be used to adhere various roofing sheets to roofs or used as a waterproofing covering for many roofing fabrics.

### Examples

Summarized in Table 1 are ethylene copolymers containing glycidyl methacrylate (GMA) with n-butyl acrylate (nBA) or vinyl acetate (VA) comonomers that are useful for blending with bitumens to provide polymer-modified asphalts.

Weight % in copolymer

| | GMA | nBA | VA | MI |
|---|---|---|---|---|
| EGMA-1 | 7.5 | 0 | 0 | 4 |
| EnBAGMA-1 | 2.5 | 28 | 0 | 2 |
| EnBAGMA-2 | 5.25 | 28 | 0 | 12 |
| EnBAGMA-3 | 9.0 | 21 | 0 | 9 |
| EnBAGMA-4 | 12.6 | 21.2 | 0 | 7.4 |
| EnBAGMA-5 | 13.9 | 20.7 | 0 | 7.4 |
| EnBAGMA-6 | 15.2 | 21.3 | 0 | 9 |
| EVAGMA-1 | 5.25 | 0 | 20 | 12 |
| EVAGMA-2 | 9-10 | | 15 | 8 |
| EVAGMA-3 | 9 | | 28 | 11.4 |
| EVAGMA-4 | 15.3 | | 14.8 | 7.8 |
| EVAGMA-5 | 16.5 | | 15 | 40 |
| EVAGMA-6 | 16.6 | | 14.7 | 7.6 |
| EVAGMA-7 | 19.2 | | 14.5 | 7.8 |

Table 2 lists some styrene copolymers available from Kraton Polymers, Inc. (Houston, Tex.) useful for blending with bitumens to provide polymer-modified asphalts.

TABLE 2

| | | Styrene | | |
|---|---|---|---|---|
| | Grade | content (weight %) | Comonomer | Description |
| SBS-1 | D1101 | 31 | butadiene | Linear triblock |
| SBS-2 | D1102 | 28 | butadiene | Linear triblock |
| SIS-1 | D1107 | 15 | isoprene | Linear triblock |

Polymers containing copolymerized GMA levels from 9% to 19.2% were added to Ajax 64-22 asphalt at 185-190° C. with stirring at 300 rpm to produce polymer modified asphalt binders (PMA's). The polymer concentration in the PMA's was 1.5 weight % in all cases. Stirring was continued for 3 or 5 hours and then Strategic Highway Research Program (SHRP) properties were measured with a Malvern Dynamic Sheer Rheometer (DSR); Model R007930. Comparative Example C4 was prepared by mixing the asphalt and the copolymer at 185-190° C. for 45 minutes, then adding 0.25 weight % of polyphosphoric acid and stirring 2 more hours.

SHRP developed tests in the 1990's to improve the prediction of road performance by measuring PMB properties and the tests were adopted by all states in the US and some foreign countries. The tests were performed in accordance with ASTM D7175-08. The PG pass/fail value (temperature) is where the complex modulus (G*) divided by the sin of the phase angle (delta) equals one (G*/sin delta=1). At temperatures above the PG pass/fail temperature pavement rutting becomes more pronounced. The phase angle, delta, is the angle between stress and strain. Lower phase angles represent higher asphalt elasticity, which is a desirable property. The data in Table 3 show the surprising and unexpected increase in PG pass/fail temperatures and reduction in phase angles when the level of copolymerized GMA in the ethylene copolymer exceeds 15.1 weight %.

TABLE 3

| | | | | | | DSR Results | | |
|---|---|---|---|---|---|---|---|---|
| | | | | | | PG | | |
| | | | | | | pass/fail | | |
| | Ethylene Copolymer | | | | | temper- | Phase | Elastic |
| Exam- | Weight % in copolymer | | | | | ature | Angle | recovery |
| ple | GMA | nBA | VA | MI | PPA | (° C.) | (°) | (%) |
| C1 | 9.0 | 21 | | 9 | 0 | 77 | 77 | |
| C1A* | 9.0 | 21 | | 9 | 0 | 82.9 | 74.22 | 71.25 |
| C2 | 12.6 | 21.2 | | 7.4 | 0 | 78.2 | 74.5 | |
| C3 | 13.9 | 20.7 | | 7.4 | 0 | 78.1 | 74.2 | |
| C4 | 9.0 | 21 | | 9 | 0.25% | 84 | 66 | 77.5 |
| 1 | 15.2 | 21.3 | | 9 | 0 | 78.9 | 73.2 | |
| 2 | 15.3 | | 14.8 | 7.8 | 0 | 78.4 | 72.33 | |
| 3 | 16.6 | | 14.7 | 7.6 | 0 | 80.5 | 68 | |
| 3A* | 16.6 | | 14.7 | 7.6 | 0 | 83.4 | 66.57 | 88.75 |
| 4 | 19.2 | | 14.5 | 7.8 | 0 | 81.4 | 68.16 | |

*stirred 5 hours

Comparison of Example 1 to Comparative Examples C1-C3 shows improved PG pass/fail temperature and phase angle when higher amounts of GMA were included in the EnBAGMA copolymer. Examples 2-4 show similar improvements using high GMA EVAGMA copolymers. Comparative Example C1A and 3A show the effect of extended mixing time, resulting in better pass/fail temperatures and phase angles. Comparative Example C4, using an ethylene copolymer with GMA level of 9 weight %, shows the effect of adding acid to accelerate mixing, leading to better performance, even with shorter mixing times. However, Example 3A using an ethylene copolymer with GMA level of 16.6 weight %, even without acid, shows comparable performance and superior elastic recovery compared to C4 wherein acid is used.

Compositions comprising bitumen, styrene copolymer and GMA-containing ethylene copolymers were prepared as summarized in Table 4, using Litvinov REF bitumen from the Czech Republic. For each formulation, bitumen was mixed with 2 weight % of SBS-1 at 185° C. for 60 minutes using a Silverson High Sheer Mill and then transferred to an IKA low-sheer mixer with a paddle mixing head where 1 weight % of the GMA-containing ethylene copolymer was added. Samples of the SBS-modified composition taken before addition of the ethylene copolymer were tested for DSR properties. The compositions were mixed for an additional 1 to 8 hours after addition of the ethylene copolymer, then allowed to cure overnight. DSR properties at 70° C. were tested at 30 minute or 1 hour intervals and the results are summarized in Table 5. Comparative Example C5 was the base bitumen without added SBS-1 or ethylene copolymer subjected to the same heat history. Comparative Example C6 was the base bitumen with added SBS-1 and an ethylene terpolymer with 9 weight % of GMA. Comparative Example C7 was the base bitumen with added SBS-1 and an ethylene dipolymer with 7.5 weight % of GMA. All polymer modified asphalts showed improved phase angle and G*/sin delta compared to the base asphalt. The dipolymer-modified asphalt had superior performance compared to the asphalt modified with the terpolymer having 9 weight % of GMA. Example 5, modified with a terpolymer having 16.5 weight % of GMA, showed superior performance over both comparative examples using polymers with less GMA. Comparative Example C10 and Example 6 were prepared similarly, except using Repsol REF bitumen from Spain. Example 6 showed excellent improvement in properties over the asphalt modified with a polymer having less GMA.

TABLE 4

| | |
|---|---|
| SBS-1 | Ethylene Copolymer |

| Example | Weight % | Name | Weight % |
|---|---|---|---|
| C5 | 0 | none | 0 |
| C6 | 2 | EGMA-1 | 1 |
| C7 | 2 | EVAGMA-3 | 1 |
| 5 | 2 | EVAGMA-5 | 1 |
| C8 | 2 | EGMA-1 | 1 |
| 6 | 2 | EVAGMA-5 | 1 |

TABLE 5

| Time after addition | DSR | | | | | | |
|---|---|---|---|---|---|---|---|
| of ethylene copolymer | Properties | | | | | | |
| (hours) | at 70° C. | C5 | C6 | C7 | 5 | C8 | 6 |
| 0 | Phase Angle (°) | | 83.67 | 84.25 | 83.03 | 78.71 | 78.06 |
| | G*/sin delta | | 0.621 | 0.698 | 0.669 | 2.33 | 2.373 |
| 1 | Phase Angle (°) | 87.05 | 80.57 | 81.89 | 80.83 | 78.44 | 74.42 |
| | G*/sin delta | 0.568 | 0.987 | 0.826 | 0.841 | 2.392 | 2.878 |
| 1.5 | Phase Angle (°) | 87.71 | 80.62 | 81.07 | 80.13 | 77.48 | 72.99 |
| | G*/sin delta | 0.549 | 1.067 | 0.862 | 0.875 | 2.531 | 3.045 |
| 2 | Phase Angle (°) | 87.66 | 80.39 | 80.03 | 77.76 | 76.52 | 71.34 |
| | G*/sin delta | 0.54 | 1.087 | 0.906 | 0.978 | 2.67 | 3.259 |
| 2.5 | Phase Angle (°) | 87.51 | 79.69 | 79.41 | 76.73 | 76.24 | 70 |
| | G*/sin delta | 0.541 | 1.17 | 0.944 | 1.034 | 2.744 | 3.406 |
| 3 | Phase Angle (°) | 87.65 | 78.68 | 78.35 | 75.93 | 75.97 | 68.95 |
| | G*/sin delta | 0.554 | 1.208 | 1.005 | 1.093 | 2.796 | 3.662 |
| 4 | Phase Angle (°) | 87.69 | 78.08 | 77.02 | 74.19 | 75.55 | 67.56 |
| | G*/sin delta | 0.556 | 1.265 | 1.062 | 1.165 | 2.874 | 3.751 |
| 5 | Phase Angle (°) | 87.59 | 78.5 | 76.08 | 73.88 | 74.36 | 66.26 |
| | G*/sin delta | 0.576 | 1.285 | 1.134 | 1.223 | 3.07 | 3.997 |
| 6 | Phase Angle (°) | 87.59 | 76.29 | 75.31 | 73.32 | 73.77 | 65.1 |
| | G*/sin delta | 0.574 | 1.344 | 1.172 | 1.28 | 3.197 | 4.342 |
| 7 | Phase Angle (°) | 87.35 | 76.03 | 74.67 | 72.25 | 73.13 | 64.46 |
| | G*/sin delta | 0.613 | 1.418 | 1.221 | 1.334 | 3.318 | 4.477 |
| 8 | Phase Angle (°) | 87.37 | 75.3 | | 71.55 | 72.22 | 63.83 |
| | G*/sin delta | 0.611 | 1.471 | | 1.395 | 3.663 | 4.612 |
| overnight | Phase Angle (°) | 87.16 | 71.67 | 69.42 | 67.52 | 68.65 | 61.68 |
| | G*/sin delta | 0.646 | 1.588 | 1.7 | 1.702 | 3.376 | 4.855 |

What is claimed is:

1. A polyepoxy-polymer-linked-asphalt composition comprising
(a) about 90 to about 99.5 weight %, based on total of component (a) and component (b), asphalt; and
(b) about 0.5 to about 10 weight %, based on total of component (a) and component (b), of an E/X/Y/Z epoxy-functionalized ethylene copolymer, wherein E is the copolymer unit (CH₂CH₂) derived from ethylene; X is the copolymer unit (CH₂CR¹R²), where R¹ is hydrogen, methyl, or ethyl, and R² is carboalkoxy, acyloxy, or alkoxy of 1 to 10 carbon atoms, present in from 0 to 40 weight % of the copolymer; Y is the copolymer unit (CH₂CR³R⁴), where R³ is hydrogen or methyl and R⁴ is carboglycidoxy or glycidoxy, present in from 15.1 to 25 weight % of the copolymer, and 0 to 10 weight % of copolymer units Z derived from comonomers including carbon monoxide, sulfur dioxide, acrylonitrile, or other monomers.

2. The polyepoxy-polymer-linked-asphalt composition of claim 1 wherein X is derived from an alkyl acrylate, alkyl methacrylate, vinyl ester, or alkyl vinyl ether; and Y is derived from glycidyl acrylate, glycidyl methacrylate, or glycidyl vinyl ether.

3. The polyepoxy-polymer-linked-asphalt composition of claim 1 wherein the epoxy-functionalized ethylene copolymer comprises about 10 weight % to about 35 weight % of C₁ to C₁₀ alkyl acrylate, based on the total weight of the epoxy-functionalized copolymer.

4. The polyepoxy-polymer-linked-asphalt composition of claim 3 wherein the alkyl acrylate comprises n-butyl acrylate.

5. The polyepoxy-polymer-linked-asphalt composition of claim 1 wherein the epoxy-functionalized ethylene copolymer comprises about 10 weight % to about 35 weight % of vinyl acetate, based on the total weight of the epoxy-functionalized copolymer.

6. The polyepoxy-polymer-linked-asphalt composition of claim 1 wherein the epoxy-functionalized ethylene copolymer comprises 0 weight % of X and 0 weight % of Z.

7. The polyepoxy-polymer-linked-asphalt composition of claim 1 wherein the epoxy-functionalized ethylene copolymer comprises 16 weight % to 25 weight % of glycidyl methacrylate, based on the total weight of the epoxy-functionalized copolymer.

8. The polyepoxy-polymer-linked-asphalt composition of claim 1 further comprising
(c) 0 to 18 weight %, based on the combination of (a), (b) and (c), of ethylene acrylate or vinyl acetate copolymer, or styrene/conjugated-diene block copolymer, or polyolefin.

9. The polyepoxy-polymer-linked-asphalt composition of claim 8 comprising a styrene/conjugated-diene block copolymer.

10. The polyepoxy-polymer-linked-asphalt composition of claim 9 wherein the styrene/conjugated-diene block copolymer comprises a styrene butadiene, or isoprene, or ethylene butene block copolymer.

11. The polyepoxy-polymer-linked-asphalt composition of claim 10 comprising 1 to 5 weight % of a styrene butadiene block copolymer.

12. The composition of claim 1 not comprising an acid or acid source.

13. The composition of claim 11 further comprising flux oil or liquid plasticizer, amine scavenger, or hydrogen sulfide scavenger, or any combination thereof.

14. The composition of claim 1 further comprising an acid or acid source, a flux oil or liquid plasticizer, amine scavenger, or hydrogen sulfide scavenger, or any combination thereof.

15. The composition of claim 8 not comprising an acid or acid source.

16. The composition of claim 15 further comprising flux oil or liquid plasticizer, amine scavenger, or hydrogen sulfide scavenger, or any combination thereof.

17. The composition of claim 8 further comprising an acid or acid source, flux oil or liquid plasticizer, amine scavenger, or hydrogen sulfide scavenger, or any combination thereof.

18. A method for preparing a polymer modified asphalt composition, the method comprising:
(1) providing an epoxy-functionalized ethylene copolymer according to claim 1; and
(2) heating and mixing the epoxy-functionalized ethylene copolymer with asphalt.

19. The method of claim 18 wherein an acid or acid source is not added to the asphalt.

20. The method of claim 18 wherein flux oil or liquid plasticizer, amine scavenger, or hydrogen sulfide scavenger, or any combination thereof is added to the asphalt.

21. The method of claim 20 wherein the epoxy-containing polymer is dissolved in flux oil or liquid plasticizer before mixing with the asphalt.

22. The method of claim 18 wherein an acid or acid source, a flux oil or liquid plasticizer, amine scavenger, or hydrogen sulfide scavenger, or any combination thereof is added to the asphalt.

23. The method of claim 18 further comprising providing a non-reactive polymer selected from ethylene acrylate or vinyl acetate copolymer, or styrene/conjugated-diene block copolymer, or polyolefin; and heating and mixing the reactive functionalized polymer with asphalt.

24. The method of claim 23 comprising
1) heating the base bitumen or asphalt to 165 to 195° C. either prior to or after addition to a reactor for modifying with the epoxy-containing polymer and the non-reactive polymer;
2) adding the non-reactive polymer to the heated asphalt in the reactor with stirring while maintaining the temperature at about 180 to about 195° C. for sufficient time to blend the non-reactive polymer with the asphalt; and
3) adding the epoxy-containing ethylene copolymer to the heated asphalt in the reactor with stirring while maintaining the temperature at about 180 to about 195° C. for sufficient time to blend the epoxy-containing polymer with the asphalt; optionally wherein flux oil or liquid plasticizer, amine scavenger, or hydrogen sulfide scavenger, or any combination thereof is added to the asphalt.

25. The method of claim 24 wherein the epoxy-containing polymer or the non-reactive polymer is dissolved in flux oil or liquid plasticizer before mixing with the asphalt.
